(19) United States
(12) Patent Application Publication
(10) Pub. No.: US 2014/0237021 A1
(43) Pub. Date: Aug. 21, 2014

(54) System and Method for Bandwidth-Delay-Product Decoupler

(71) Applicant: BROADCOM CORPORATION, Irvine, CA (US)

(72) Inventors: Lowell David Lamb, San Ramon, CA (US); Lawrence Drew Davis, Petaluma, CA (US); Glen Kramer, Petaluma, CA (US); Wael William Diab, San Francisco, CA (US)

(73) Assignee: BROADCOM CORPORATION, Irvine, CA (US)

(21) Appl. No.: 13/798,625

(22) Filed: Mar. 13, 2013

Related U.S. Application Data
(60) Provisional application No. 61/765,299, filed on Feb. 15, 2013.

(51) Int. Cl. H04L 29/06

(52) U.S. Cl. CPC H04L 67/42
USPC 709/203

(57) ABSTRACT

A system and method for bandwidth-delay-product (BDP) decoupler. A BDP decoupler mechanism is provided that enables an intermediate network device to facilitate an efficient transfer of traffic from a server to a client. In one embodiment, the intermediate network device can be configured to buffer received data and control the transmission of the buffered data to the client device based on acknowledgment messaging received by the intermediate network device from the client device.

This application claims priority to provisional application No. 61/765,299, filed Feb. 15, 2013, which is incorporated herein by reference in its entirety.

### BACKGROUND

1. Field of the Invention

The present invention relates generally to networking and, more particularly, to a system and method for bandwidth-delay-product decoupler.

2. Introduction

Data communication networks continue to expand in reach and capacity. The continual evolution of data communication networks presents continuing challenges in coordinating the transport of various forms of network traffic from various sources. Interconnection of customer networks (e.g., residential), access networks, and metro/core networks present significant challenges in addressing quality of service demands for various types of network traffic.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example embodiment of a bandwidth-delay-product decoupler.

FIG. 2 illustrates an example network application of a bandwidth-delay-product decoupler.

FIG. 3 illustrates an example process of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Customer networks, access networks, and metro/core networks provide a transport framework for today's data communications needs. These various networks exhibit various performance characteristics such as packet loss, dynamically changing bandwidth restrictions, excessive latency, or variable latency that can impact end-to-end network transport.

In the present invention, a bandwidth-delay-product (BDP) decoupler mechanism is provided that enables an intermediate network device to facilitate an efficient transfer of traffic from a server to a client. In one embodiment, the intermediate network device receives data from a server device that has a client device as a destination. The intermediate network device can be configured to buffer the received data and control the transmission of the buffered data to the client device based on acknowledgment messaging received by the intermediate network device from the client device.

In general, the BDP decoupler mechanism enables greater network efficiency by addressing imbalances between network transport segments that have different bandwidth and latency characteristics, often described by a computed bandwidth-delay product per segment. For example, the BDP decoupler mechanism can facilitate greater network efficiency in decoupling a first network segment having a high-bandwidth, low-delay characteristic from a second network segment having a low-bandwidth, high-delay characteristic.

In general, the BDP decoupler mechanism can operate transparently from the perspective of either the server device or the client device. For example, the BDP decoupler mechanism can terminate and/or add acknowledgment messaging in a manner that is transparent to the operation of the server device or the client device.

In one application, the BDP decoupler mechanism can be configured to facilitate Transmission Control Protocol (TCP) traffic or traffic based on another acknowledgment-based protocol between the server device and client device. In another application, the BDP decoupler mechanism can be configured to facilitate User Datagram Protocol (UDP) traffic or traffic based on a protocol without an acknowledgment mechanism between the server device and client device.

In various embodiments, the BDP decoupler mechanism can be implemented in an edge switch, an optical line terminal (OLT) in a passive optical network (PON) system, a digital subscriber line access multiplexer (DSLAM), a wireless device (e.g., Wi-Fi, WiMax, etc.), or any other device that is located at or near an interface between network segments having different network performance characteristics. In various embodiments, the BDP decoupler mechanism can be activated during a provisioning process or via an auto-detection process that examines a traffic flow based on characteristics such as a port number, a protocol type, a server address, a flow identifier, or the like. In various examples, the operation of the BDP decoupler mechanism can also be based on a Logical Link Identifier (LLID) in an Ethernet Passive Optical Network (EPON) system, an Alloc_ID or GEM Port-ID in a G-PON system, a Service Set Identifier (SSID) in a Data Over Cable Service Interface Specification (DOCSIS), a subscriber line in a Digital Subscriber Line (DSL) system, or the like.

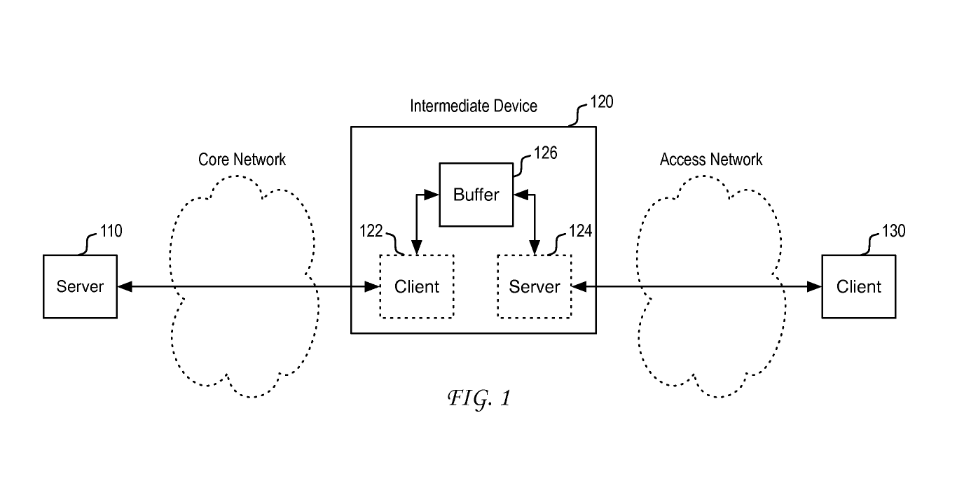

To illustrate the features of the present invention reference is made first to the example illustration of a BDP decoupler in FIG. 1. As illustrated, the BDP decoupler mechanism is incorporated in intermediate device 120, which resides between server 110 and client 130. In one example, intermediate device 120 can be located at or near an interface between network segments having different network performance characteristics (e.g., different bandwidth-delay products). In the illustration of FIG. 1, the two different network segments are a core network segment and an access network segment. As would be appreciated, a core network segment can exhibit high-bandwidth, low-delay transport characteristics, while the access network segment can exhibit low-bandwidth, high-delay transport characteristics.

In this example context, the access network portion can be represented by a PON connection, a DSL connection, or the like. As such, intermediate device 120 can be embodied as an edge switch, an OLT, a DSLAM, or the like. As would be appreciated, the particular intermediate network device in which the principles of the present invention are implemented would be implementation dependent.

In a conventional network connection between a server and a client across network segments having different network performance characteristics, significant transport inefficiency can result. Consider, for example, a TCP/IP connection between a server and a client. In this example, the TCP/IP connection would start with a small transport window size, and slowly increase the transport window size until failures in the connection occur. These failures would be detected through the absence of receipt of acknowledgment messages from the client.

In general, such failures would likely occur in a segment of a transport network that exhibits low bandwidth, high-delay characteristics, which can lead to high packet loss. Examples of such segments of the transport network include the access network. In contrast, the core network can facilitate high-bandwidth, low-delay characteristics, which can lead to low packet loss.

In the present invention, it is recognized that the low-bandwidth, high-delay characteristics of one segment of the network can lead to significant inefficiencies in the end-to-end connection. In the TCP/IP connection example, the high packet loss in the access network can lead to substantial transport inefficiencies as re-transmissions from the server to the client across the length of the end-to-end connection would be needed upon the lack of acknowledgment form the client.

In the present invention, it is recognized that transmission profiles can be decoupled and separately optimized for each individual network segment. FIG. 1 illustrates such a decoupling as intermediate device 120 can be configured to decouple the core network transmission from the access network transmission. In one embodiment, intermediate device 120 is configured to incorporate client 122 for communication with server 110, and to incorporate server 124 for communication with client 130. Communication between client 122 and server 124 is facilitated by buffer 126. As will be described in greater detail below, a controller in intermediate device 120 can be configured to monitor the operation of buffer 126 in controlling the relative operation of client 122 and server 124.

To illustrate such control, consider again the TCP/IP example where the access network segment exhibits a relatively high packet loss as compared to the core network segment. As the core network has a relatively low packet loss, client 122 would respond to server 110 with acknowledgment messaging that the packets have been received. Note, of course, that intermediate device 120 is not the final destination of the packets. As such, the packets received at intermediate device 120 would be stored in buffer 126.

Buffer 126 is the source of packets that are transmitted by server 124 to client 130 over the access network. As the access network has a relatively high packet loss, the lack of receipt of acknowledgment messaging by server 124 from client 130 can lead server 124 to retransmit the unacknowledged packets. Significantly, the source of the packets that are to be retransmitted is located in buffer 126 in intermediate device 120, as compared to server 110.

In the present invention, it is recognized that the buffering of packets in buffer 126 in intermediate device 120 effectively decouples the core network from the access network. The otherwise reliable transmission from server 110 to client 122 can proceed without being burdened by the limitations effectively imposed by the access network. One of the benefits of such a decoupling is that the communication between server 110 and client 122 can increase the window size as failures in the core network are limited. Efficiency in the core network communication is thereby increased as compared to core network communication that is limited by the access network.

In one embodiment, a controller in intermediate device 120 can monitor the relative fullness of buffer 126 to control the relative rate of filling of buffer 126. This control can be implemented through the control of acknowledgment messaging that is sent by client 122 to server 110. Where buffer 126 is not being drained fast enough due to packet loss in the access network, client 122 can slow down the rate of acknowledgment messaging sent to server 110 to thereby slow down the rate of transmission to client 122. Optimization of the use of buffer resources is thereby effected.

On the access network facing side of intermediate device 120, server 124 can be configured to send buffered data to client 130. In this segment of the network, the relatively high packet loss is largely governed by the operation of server 124 in re-transmitting lost packets to client 130. In this process, the packets that are transmitted to client 130 by server 124 have effectively been pre-fetched from server 110 and stored in buffer 126. Deficient transmission performance in the access network has therefore had minimal effect on the transmission across the core network. Here, it should be noted that the user experience at client 130 has been improved as the delay in the retransmission of packets has been reduced through the pre-fetching by intermediate device 120.

In accordance with the present invention, the operation of the BDP decoupler mechanism can be performed transparently to server 110 and client 130. In other words, both server 110 and client 130 are unaware of the operation of client 122 and server 124, respectively, in intermediate device 120. From the perspective of server 110, it is interacting with client 130, and from the perspective of client 130, it is interacting with server 110.

In one embodiment, the BDP decoupler mechanism in intermediate device 120 can be activated via provisioning. In another embodiment, the BDP decoupler mechanism can be activated via auto-detection. For example, intermediate device 120 can monitor traffic on the link for a pre-determined flow signature. Potential elements of such a flow signature can include one or more of a port number, a protocol type, a server address, or the like. In general, any element of a data packet at any layer (e.g., discovered via deep packet inspection) that can provide an indication of traffic that could benefit from the BDP decoupler mechanism can be used. In one example, the operation of the BDP decoupler mechanism can also be based on a LLID in an EPON system, an Alloc_ID or GEM Port-ID in a G-PON system, an SSID in a DOCSIS system, a subscriber line in a DSL system, or the like. For instance, such an indicator can provide insight into a quality of service (QoS) or other performance characteristic relevant to a service level agreement (SLA).

As has been described, the operation of the BDP decoupler mechanism can effectively hide client-side packet loss in the access network segment from the server. This allows the core network segment to operate at maximum efficiency (e.g., large window sizes, minimal number of retries, etc.).

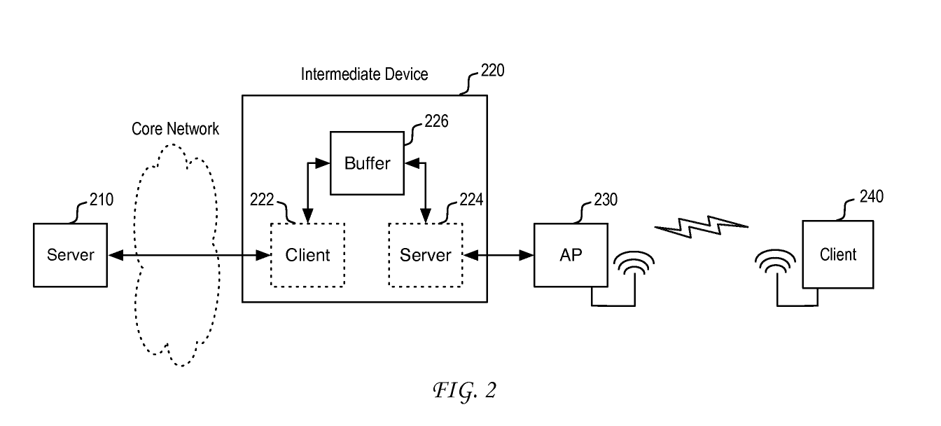

To further illustrate an impact of the principles of the present invention, consider the example network environment of FIG. 2. As illustrated, intermediate device 220 is positioned between server 210 and client 240. In a manner similar to FIG. 1, the network segment between server 210 and intermediate device 220 is exemplified by a core network segment. The network segment between intermediate device 220 and client 240, on the other hand, is an access network segment that includes a wireless link (e.g., IEEE 802.11 Wi-Fi) between wireless access point 230 and client 240. In one example, wireless access point 230 can be incorporated as part of an optical network unit (ONU) in a PON system, wherein the connection between the ONU and intermediate device 220 (e.g., OLT) is via a point-to-multipoint fiber optic transport system.

In the example of FIG. 2, the BDP decoupler mechanism includes client 222, which is configured for communication with server 210 across the core network segment, and server 224, which is configured for communication with client 240 over the access network segment. In a manner similar to FIG. 1, communication between client 222 and server 224 is facilitated by buffer 226.

As noted above in the context of a TCP/IP example, the low-bandwidth, high-delay characteristic of the access network segment can lead to numerous retries by server 224 based on the lack of receipt of acknowledgment messaging from client 240. In the further example of FIG. 2, the wireless link between access point 230 and client 240 can also include a retry mechanism that operates independently of the BDP decoupler mechanism in intermediate device 220. This nested retry mechanism within the access network segment would not present an operational conflict as the transmission retries at intermediate device 220 would be governed by the receipt of acknowledgment messaging at server 224.

Here, it should be noted that the connection of a client to an intermediate device using a wireless connection may exhibit greater packet loss as compared to the connection of another client to an intermediate device using a wired connection (e.g., wired LAN). These two different client connections illustrate different types of control (e.g., amount of buffering, number of retries, etc.) that can be instituted by the BDP decoupler mechanism.

As noted above, the BDP decoupler mechanism can be activated via auto-detection. This auto-detection process can be designed to determine different connection types via data contained in the traffic itself (e.g., client identifiers, line identifiers, traffic/protocol type identifiers, etc.), and/or can determine different connection types via a monitoring of performance metrics (e.g., packet loss, number of retries, error rate, etc.).

In the above examples, the principles of the present invention were described in the context of TCP/IP traffic. As would be appreciated, the scope of the present invention is not so limited. Other traffic types can also benefit from the BDP decoupler mechanism.

For example, the principles of the present invention can also be applied to UDP traffic. In this example, the BDP decoupler mechanism would buffer traffic between a client and server in the intermediate device in a similar manner described in FIGS. 1 and 2. As UDP does not have retries, a retry mechanism can be implemented in the network segment between the intermediate device and the client. In one example, UDP can be used between the server and the intermediate device, and TCP can be used between the intermediate device and the client. The addition of a retry mechanism in the network segment between the intermediate device and the client enables the client to take advantage of the buffering at the intermediate device. In conventional UDP connections between the server and the client, the usage of a retry mechanism between the server and client is impractical because of the large delay across the network. As would be appreciated other retry mechanisms in the network segment between the intermediate device and the client can be used. For example, the UDP flow can be encapsulated in a retry protocol between the intermediate device and the client. In one embodiment, marker frames can be inserted into the UDP flow to thereby enable tracking of UDP transmission and allow the client to acknowledge the successful arrival of UDP traffic.

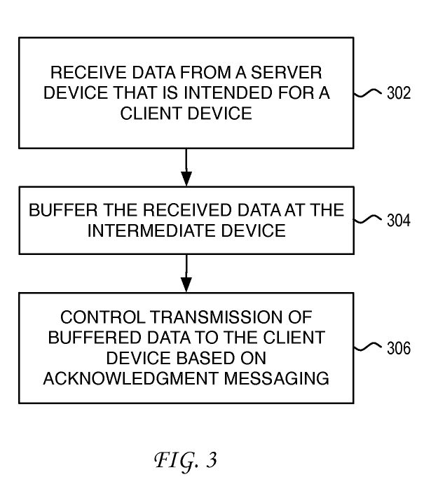

Having described a general framework of operation of a BDP decoupler mechanism, reference is now made to FIG. 3, which illustrates a flowchart of a process of the present invention. As illustrated, the process begins at step 302 where data is received by an intermediate device from a server device that has a client device as its destination. As configured by the intermediate device, the data is received at a client that has been provisioned or otherwise activated at the intermediate device on behalf of the destination client device.

Next, at step 304, the received data is buffered at the intermediate device. As the provisioned or activated client in the intermediate device operates on behalf of the destination client device, the client in the intermediate device can send a message to the server device acknowledging receipt of the traffic. From the perspective of the server device, the receipt of the acknowledgment message would indicate that the destination client device actually received the data. In one embodiment, the transmission of acknowledgment messages from the client in the intermediate device to the server device can be controlled to optimize the use of transmission and buffering resources.

Having buffered the received data at the intermediate device, a provisioned or otherwise activated server at the intermediate device can then control, at step 306, the transmission of buffered data to the destination client device based on acknowledgment messaging received from the destination client device. This control would address the higher packet loss rate in the network segment between the intermediate device and the destination client device in a manner that would not produce transport inefficiencies in the network segment between the server device and the intermediate device.

In general, the BDP decoupler mechanism of the present invention can be used to improve the performance of any network that has a mismatch between a high-speed, low-latency network segment and a low-speed, high-latency network segment. For example, a low-speed, high-latency network segment can be represented by a PON segment (e.g., EPON or GPON), a twisted-pair network segment (e.g., dial-up, xDSL, etc.), a coax-based network segment (e.g., DOCSIS, MOCA, etc.), a wireless-based network segment (e.g., Wi-Fi, etc.), a power-line based network segment, etc.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method, comprising:
receiving, by an intermediate network device, data from a server device that has a client device as a destination;
buffering, by said intermediate network device, said received data from said server device; and
controlling a transmission of said buffered data to said client device based on acknowledgment messaging received by said intermediate network device from said client device, wherein said server device is unaware of said acknowledgment messaging from said client device.

2. The method of claim 1, wherein said receiving comprises receiving traffic from said server device based on a Transmission Control Protocol (TCP) or other acknowledgment based protocol.

3. The method of claim 1, wherein said receiving comprises receiving traffic from said server device based on a User Datagram Protocol (UDP) or a protocol without an acknowledgment mechanism.

4. The method of claim 1, wherein said intermediate network device is an edge switch.

5. The method of claim 1, wherein said intermediate network device is an optical line terminal in a passive optical network (PON) system.

6. The method of claim 1, wherein said intermediate network device is a digital subscriber line access multiplexer (DSLAM).

7. The method of claim 1, wherein said intermediate network device is a wireless device.

8. The method of claim 1, wherein said acknowledgment messaging is based on the Transmission Control Protocol (TCP).

9. The method of claim 1, wherein said acknowledgment messaging is part of a protocol that encapsulates User Datagram Protocol (UDP) traffic.

10. The method of claim 1, wherein activation of said buffering occurs during a provisioning process.

11. The method of claim 1, wherein activation of said buffering occurs via an auto-detection process by said intermediate network device.

12. The method of claim 1, wherein activation of said buffering is based on a discovery of an identifier for an access network portion that facilitates communication between said intermediate network device and said client device.

13. The method of claim 12, wherein said identifier is one of a Logical Link Identifier (LLID) in a Ethernet Passive Optical Network (PON) system, an Alloc_ID or GEP Port-ID in a G-PON system, a Service Set Identifier (SSID) in a Data Over Cable Service Interface Specification (DOCSIS), and a line in a Digital Subscriber Line (DSL) system.

14. A network device, comprising:
a receiver that is configured to receive data from a server device that has a client device as a destination;
a buffer that is configured to store said received data from said server device; and
a controller that is configured to control a transmission of said buffered data to said client device based on acknowledgment messaging received by said network device from said client device, wherein said server device is unaware of said acknowledgment messaging from said client device.

15. The network device of claim 14, wherein said data is received based on a Transmission Control Protocol (TCP) or another acknowledgment based protocol.

16. The network device of claim 14, wherein said data is received based on a User Datagram Protocol (UDP) or other protocol without an acknowledgment mechanism.

17. The network device of claim 14, wherein said network device is an optical line terminal in a passive optical network (PON) system.

18. The network device of claim 14, wherein said network device is a digital subscriber line access multiplexer (DSLAM).

19. The network device of claim 14, wherein said network device is a switch.

20. The network device of claim 14, wherein said network device is a wireless device.
